(19) United States
(12) Patent Application Publication
(10) Pub. No.: US 2002/0184090 A1
(43) Pub. Date: Dec. 5, 2002

(54) Paidpostage computerized method and system

(75) Inventor: Nicholas G. Jenkins, Seattle, WA (US)

Correspondence Address: Brinks Hofer Gilson & Lione, P.O. Box 10395, Chicago, IL, 60610, US

(73) Assignee: TheFence.com, Inc.

(21) Appl. No.: 09/870,352

(22) Filed: May 30, 2001

(51) Int. Cl. G06F 17/60

(52) U.S. Cl. 705/14; 705/39

(57) ABSTRACT

Computer-assisted methods and systems are provided to allow computer network users to be compensated by other users for their commentary posted on the computer network. One method comprises the steps of: inputting commentary of a first user into a computer; and providing a payment from a second user to the first user. Another method comprises the steps of: inputting commentary of a first user into a computer; inputting into the computer a payment identifier specifying a financial account of a second user; allotting pre-paid credits to the second user by charging the second user's financial account for use of the credits; and providing a payment to the first user using the pre-paid credits of the second user. A provided apparatus comprises: a storage device; and a processor connected to the storage device, wherein the processor is operative to receive commentary of a first user, and to provide a payment from a second user to the first user.

### BACKGROUND

In today's world, the Internet plays an important part of most peoples lives. In part, the Internet allows people to express their opinions (commentary) to the outside world. To date, an opinion writer's reward for a well-written opinion posted over the Internet has been an e-mail or post from another Internet user complimenting the opinion.

### BRIEF SUMMARY

Methods and systems are provided to allow computer network users to be compensated by other users for their commentary posted on the computer network.

In a preferred embodiment, the method comprises the steps of: inputting commentary of a first user into a computer; and providing a payment from a second user to the first user.

In another embodiment, the method comprises the steps of: inputting commentary of a first user into a computer; inputting into the computer a payment identifier specifying a financial account of a second user; allotting pre-paid credits to the second user by charging the second user's financial account for use of the credits; and providing a payment to the first user using the pre-paid credits of the second user.

In another embodiment, the apparatus comprises: a storage device; and a processor connected to the storage device. The processor is operative to receive commentary of a first user, and to provide a payment from a second user to the first user.

The present invention, together with further objects and advantages, will be best understood by reference to the following detailed description taken in conjunction with the accompanying drawing.

### BRIEF DESCRIPTION OF THE DRAWING

FIG. 1 is a flow chart showing a preferred embodiment of the computer-assisted commentary payment method.

FIG. 2 is a block diagram showing a preferred embodiment of the computer-assisted commentary payment system.

### DETAILED DESCRIPTION OF THE INVENTION

The present invention relates in general to a computer-assisted method and system implemented over a computer network to allow users to be compensated for commentary posted on the computer network. Commentary includes but is not limited to opinions, arguments, conclusions, inquiries, and other types of feelings expressed by the user. More specifically, in one embodiment, the invention allows Internet users to compensate other global Internet users for posted commentary.

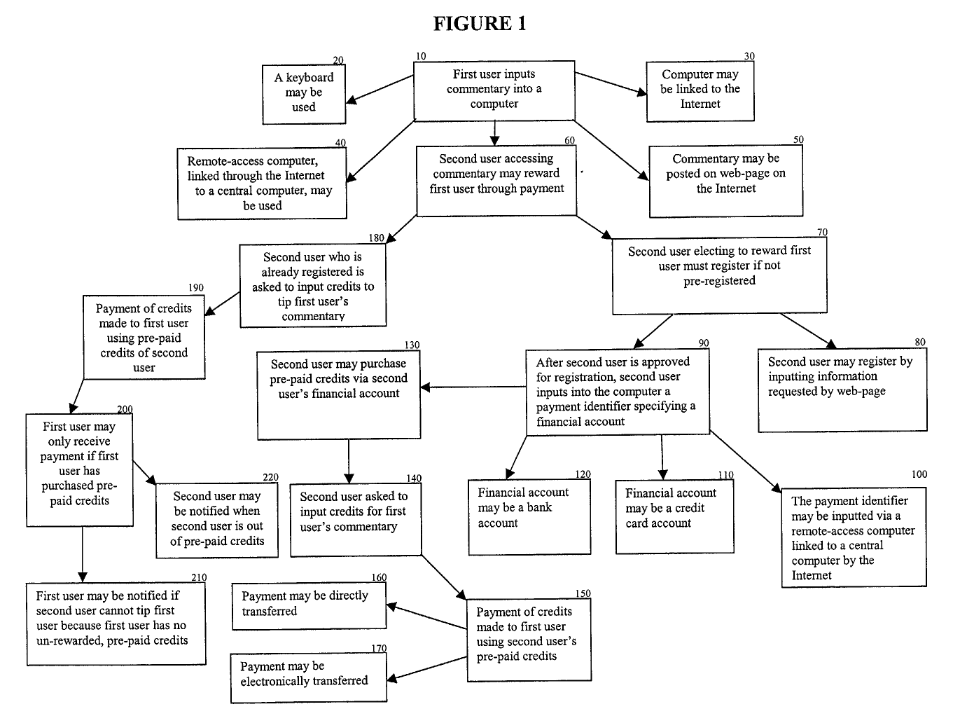

As shown in FIG. 1, in one embodiment, commentary of a first user is initially input into a computer 10. The commentary may be entered using a keyboard 20 or transferred from another computer. Preferably, the computer into which the commentary is inputted is linked to the Internet 30. For example, the commentary may be inputted into a remote-access computer linked through the Internet to a central computer 40 (e.g. server). Upon being input, the commentary may be posted on a web-page on the Internet. Other Internet users may be able to access the commentary by accessing the web-page where the commentary is posted 50. When a second user having access to the first user's commentary finds the commentary insightful, the second user has the option of rewarding the commentary through payment 60. In one embodiment, the second user elects to reward commentary by clicking on an icon on the web-page.

When the second user elects to reward the first user for insightful commentary and is not a registered member holding pre-paid credits, the second user is prompted to register 70. The second user may be provided a registration web-page where the user inputs information required for registration 80. Some of the types of information which may be required to register include the user's name, address, e-mail address, phone number, social security number, and financial information. An Internet web-site, such as Amazon.com, may be used for registration and payment.

If the second user's application is approved for registration, the second user then inputs into the computer a payment identifier specifying a financial account of the user 90. The payment identifier may be inputted through a remote access computer linked through the Internet to a central computer 100. Among other types of accounts, the financial account may be a credit card account 110 or a bank account 120. The second user is then given the option of purchasing pre-paid credits through the second user's specified financial account 130. In one embodiment, each credit is worth twenty-five cents, and the second user pays ten dollars for a six dollar package of credits. In another embodiment, the pre-paid credits are non-refundable.

After the second user has registered and obtained pre-paid credits, the second user is allowed to reward the commentary of other users. The second user is asked to input the amount of money or number of credits he wishes to reward the first user for commentary found to be insightful 140. After the second user enters the amount of money or number of credits into the computer, a payment of money or credits is provided to the first user using the pre-paid credits of the second user 150. In other embodiments, the payment from the second user to the first user may be directly transferred 160 or electronically transmitted 170.

If the second user is already a registered member holding pre-paid credits when he elects to reward the first user for insightful commentary, the second user is asked to input the amount of money or number of credits to reward the first user in response to selecting a reward icon 180. After the second user enters the amount of money or number of credits into the computer, a payment of credits or money is provided to the first user using the pre-paid credits of the second user 190.

In one embodiment, the first user may only receive pre-paid credits from a second user if the first user has purchased pre-paid credits to distribute to other users 200. In such an embodiment, to be eligible to receive pre-paid credits from a second user, the first user inputs into the computer a payment identifier specifying a financial account. Additionally, in order to be eligible to receive pre-paid credits, the first user purchases pre-paid credits using the first user's specified financial account. Finally, to be eligible to receive pre-paid credits from a second user, the first user has un-rewarded, pre-paid credits at the time of the reward. Any of the above payment limitations may be optional, and other payment limitations may be used.

In another embodiment of the embodiment where the first user may only receive pre-paid credits from a second user if the first user has purchased pre-paid credits to distribute to other users, the first user is notified if the second user attempts to reward the first user's commentary but is unable to do so because the first user does not fulfill a requirement 210. In another embodiment, the second user is notified when the second user's pre-paid credits have all been paid out 220.

In one embodiment, users who have accumulated credits are paid quarterly. In another embodiment, users who have accumulated credits accumulate at least five dollars worth of credits to be paid. However, in other embodiments, different payment criteria and time-schedules may be set.

In another embodiment, detailed summaries of a user's account may be accessed over the Internet. One such summary includes a total earned credit calculation, or total earned money calculation, setting forth the total credits, or total amount of money, the user has been paid by other users for the user's commentary. Another such summary includes an unearned credit calculation, or unearned money calculation, setting forth the total credits, or total amount of money, the user lost out on the opportunity to receive because the user did not have un-rewarded, pre-paid credits at the time other users attempted to pay credits for the user's commentary. Yet another such summary includes the total number of pre-paid credits, or amount of money, the user has available to pay out to other users. Additionally, another such summary includes total paid out credits, or total paid out money, setting forth the total amount of credits, or the total amount of money, the user has paid out to other users.

Another such summary includes a rating of the user's commentary as determined by the weighted rankings other users give to the user's commentary. For example, other users may be requested to rate a user's commentary on a scale of one to ten, and a mean value may be determined. Yet another such summary includes a composite rating of the user as determined by an algorithm. For example, the user's composite rating may be determined by the following algorithm: Composite rating=P+2*E+4*T, where P is the total number of commentary posts left on a web-site by a user; E is the user's total earned credit calculation setting forth the total credits the user has earned; and T is the total amount of credits the user has paid out to other users. Other algorithms may be used. In one embodiment, an award is given to the user with the highest composite rating, overall ranking, or other criteria.

In another such summary, a user's tip (or credit) average is shown. The tip average may be defined by the number of times other users have tipped (or credited) the user's commentary divided by the total number of commentary posts the user has posted. Yet another such summary includes a user's earning average. The user's earning average may be defined by the total credits, or total amount of money, the user has earned divided by the total number of commentary posts the user has posted.

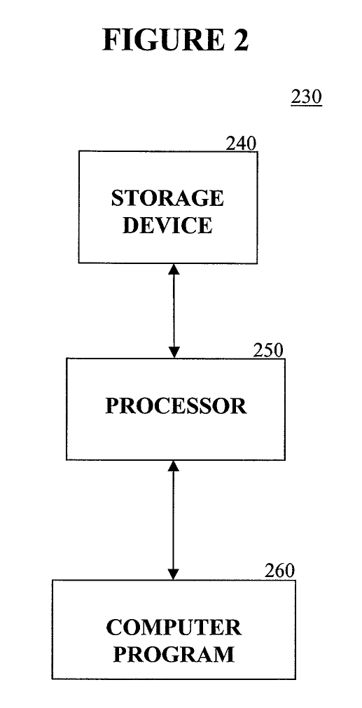

As shown in FIG. 2, a computer system 230 may be utilized to allow rewards for user commentary. The computer system 230 comprises a storage device 240, and a processor 250 connected to the storage device 240. The processor 250 is operative to receive commentary of a first user, and to provide a payment from a second user to a first user. In another embodiment, the processor 250 is operative to receive a payment identifier specifying a financial account of the second user, and to provide payment of the first user using the payment identifier of the second user.

In an embodiment, a computer program 260 uses a technique of control-action-response (CAR) for receiving information from a user of the computer system. For CAR techniques, the user response determines the behavior of the program by detailing the response of the program to each user action on each control of the window. A “control” is anything that a user can activate, click-on or drag to do something in an application window, including radio buttons, scroll choices, or entry fields, which allow for entry of data via a keyboard or other input device. Each control requires one or more actions, such as double-clicking, single-clicking, entering data, selecting, and so on. A “response” is the action of the computer program to the action of the user. CAR techniques are often used at a high level of programming, but may also be used to govern the response at a detailed level, such as in a payment program rewarding a user's commentary over the Internet.

These techniques and others may be used to obtain relevant data from the user. In one embodiment, a template of predetermined questions may be formulated with the control techniques mentioned above. The user is then required to enter data, such as by selecting from one or more options, or by entering data from the keyboard, or by retrieving data from at least one database. In response to these actions, the computer program then asks questions in order to provide a payment to a user for commentary.

It will be appreciated that a wide range of changes and modifications to the methods and systems as described are contemplated. Accordingly, while preferred embodiments have been shown and described in detail by way of examples, further modifications and embodiments are possible without departing from the scope of the invention. It is therefore intended that the invention be defined by the appended claims and all legal equivalents.

We claim:

1. A method for using a computer to reward commentary comprising:
(a) inputting commentary of a first user into the computer; and
(b) providing a payment from a second user to said first user.

2. The method of claim 1, in which (b) comprises:
inputting into the computer a payment identifier specifying a financial account of the second user, wherein a payment is provided to said first user using the payment identifier of said second user.

3. The method of claim 1, in which (a) comprises:
inputting commentary into the computer with a keyboard.

4. The method of claim 1, wherein said computer is linked to the Internet.

5. The method of claim 2, wherein said payment identifier is input using at least one other computer linked to the Internet.

6. The method of claim 1, wherein the inputted commentary is posted on a web-page on the Internet.

7. The method of claim 6, wherein said second user accesses the inputted commentary of said first user through said web-page.

8. The method of claim 2, wherein said financial account is a credit card account.

9. The method of claim 2, wherein said financial account is a bank account.

10. The method of claim 1, wherein (b) further comprises said second user purchasing pre-paid credits.

11. The method of claim 10, wherein said first user may only be provided with payment from said second user for said commentary if said first user has purchased pre-paid credits to reward commentary, and said first user has un-rewarded pre-paid credits.

12. The method of claim 11, further comprising notifying the first user if said second user attempts to reward said first user's commentary, but is not able to do so because said first user does not have un-rewarded pre-paid credits.

13. The method of claim 10, wherein said second user is notified when said second user's pre-paid credits have all been paid out.

14. The method of claim 1, in which (b) comprises:
transferring payment from said second user to said first user.

15. An apparatus for rewarding commentary, comprising:
a storage device; and
a processor connected to the storage device, wherein the processor is operative to receive commentary of a first user, and to provide a payment from a second user to said first user.

16. The apparatus of claim 15, in which the processor is operative to receive a payment identifier specifying a financial account of the second user, and to provide payment of said first user using the payment identifier of said second user.

17. The apparatus of claim 15, in which the processor is operative to receive commentary of said first user through a keyboard.

18. The apparatus of claim 15, in which the processor is linked to the Internet.

19. The apparatus of claim 16, in which the payment identifier is received using one or more computers linked to the Internet.

20. The apparatus of claim 15, wherein the received commentary is posted on a web-page on the Internet.

21. The apparatus of claim 20, wherein said second user accesses the received commentary of said first user through said web-page.

22. The apparatus of claim 16, wherein said financial account is a credit card account.

23. The apparatus of claim 16, wherein said financial account is a bank account.

24. The apparatus of claim 15, wherein said processor is further operative to allow said second user to purchase pre-paid credits.

25. The apparatus of claim 24, wherein said first user may only be provided with payment from said second user for said commentary if said first user has purchased pre-paid credits to reward commentary, and said first user has un-rewarded pre-paid credits.

26. The apparatus of claim 25, further comprising notifying the first user if said second user attempts to reward said first user's commentary, but is not able to do so because said first user does not have un-rewarded pre-paid credits.

27. The apparatus of claim 24, wherein said second user is notified when said second user's pre-paid credits have all been paid out.

28. The apparatus of claim 15, wherein said payment of said first user is provided by transferring payment from said second user to said first user.

29. A method for using a computer to reward commentary comprising:
(a) inputting commentary of a first user into the computer;
(b) inputting into the computer a payment identifier specifying a financial account of a second user;
(c) allotting pre-paid credits to said second user by charging said second user's financial account for use of said credits; and
(d) providing a payment to said first user using the pre-paid credits of said second user.

30. The method of claim 29, further including the step of said second user accessing the commentary of said first user.
